(19) United States
(12) Patent Application Publication
(10) Pub. No.: US 2023/0026762 A1
(43) Pub. Date: Jan. 26, 2023

(54) EQUITABLE TICKET EXCHANGE AMONG TICKET HOLDERS

(71) Applicant: Cristyan CRESPO, Roanoke, TX (US)

(72) Inventor: Cristyan CRESPO, Roanoke, TX (US)

(21) Appl. No.: 17/384,012

(22) Filed: Jul. 23, 2021

(51) Int. Cl. G06Q 30/06; G06Q 10/02

(52) U.S. Cl. CPC G06Q 30/0619; G06Q 10/02

(57) ABSTRACT

Apparatus and methods for ticket exchange. In an exemplary method, ticket exchange information is received from a plurality of users offering tickets for exchange. Each of the plurality of users is a season ticket holder with a set of tickets permitting attendance to a plurality of events over a period of time. The ticket exchange information identifies at least an event and seating information for the event. The method also includes steps of presenting the tickets for exchange to the plurality of users, receiving a request from a requesting user from the plurality of users for tickets from the tickets for exchange; and transferring the requested tickets from an original owner of the tickets to the requesting user.

### BACKGROUND

### Technical Field

Novel aspects of the present disclosure relate to the field of ticket management and more particularly to an apparatus a methods for equitable exchange of tickets between users of a ticket exchange marketplace.

### Background

Spectator sports generate significant amounts of revenue. When watched on TV, advertising revenue can be generated, sometimes at astronomical levels during high-profile events like the Super Bowl. Over time, significant amounts of revenue can be generated when sports events are attended in-person. The revenue streams can be attributed to parking fees, tickets, souvenirs, and food and beverages. As of 2019, the average family of four in the United States pays about $400 to attend a professional football game, about $230 to attend a professional baseball game, over $440 to attend a professional basketball game, and about $420 to attend a professional hockey game. Taking professional baseball in the United States as an example, if the average attendance for a game is approximately 30,000 people, then each game generates approximately $1.7 million in revenue. About half of the games in a 162 game season are played at home, which means that an arena can generate nearly $140 million when the games are attended in-person.

Some casual sports fans will purchase tickets for a few home games and watch the remainder of the games on television. Some of the more dedicated fans will buy season tickets to watch their favorite team. The season tickets allow the purchaser to watch every home game played in that arena. These season ticket holders generally spend more money at each game than the casual sports fans who attend on a few games each season. Thus, facilitating attendance of season ticket holders can result in an immediate increase in revenue for not only the local sports team, but also the owners of the arena also local vendors inside and outside of the arena. This result is important because in-person attendance of spectator sports have been steadily declining. Referring back to the example of professional baseball in the United States, the average per-game attendance has dropped about 7.3% over the most recent 10-year period.

### SUMMARY OF THE INVENTION

Novel aspects of the present disclosure are directed to a method for ticket exchange. The method includes the step of receiving ticket exchange information from a plurality of users offering tickets for exchange. Each of the plurality of users is a season ticket holder with a set of tickets permitting attendance to a plurality of events over a period of time. The ticket exchange information identifies at least an event and seating information for the event. The method also includes steps of presenting the tickets for exchange to the plurality of users, receiving a request from a requesting user from the plurality of users for tickets from the tickets for exchange; and transferring the requested tickets from an original owner of the tickets to the requesting user.

Novel aspects of the present disclosure are also directed to an apparatus for ticket exchange. The apparatus includes memory configured to store instructions and a processor coupled with the memory which is configured to execute the instructions to receive ticket exchange information from a plurality of users offering tickets for exchange. Each of the plurality of users is a season ticket holder with a set of tickets permitting attendance to a plurality of events over a period of time. Further, the ticket exchange information identifies at least an event and seating information for the event. The processor is also configured to execute the instructions to present the tickets for exchange to the plurality of users, receive a request from a requesting user from the plurality of users for tickets from the tickets for exchange, and transfer the tickets from an original owner of the tickets to the requesting user.

Novel aspects of the present disclosure are also directed to another method for ticket exchange. The method includes a step of providing ticket exchange information that offers one or more tickets for exchange. The one or more tickets permit attendance to a plurality of events over a period of time, and the ticket exchange information identifies at least an event and seating information for the event. The method also includes the steps of receiving a list of available tickets for exchange offered by other users and which result in equitable ticket trades, submitting a request for tickets from the available tickets for exchange, and receiving the requested tickets.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE FIGURES

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying figures, wherein:

FIG. 1 is a block diagram of a system for ticket exchange according to an illustrative embodiment;

FIG. 2 is a block diagram of a mobile computing device for ticket exchange according to an illustrative embodiment;

FIG. 3 is a flowchart of a server for ticket exchange according to an illustrative embodiment;

FIG. 4 is a seating map of a first arena with seating levels usable for determining equitable ticket exchange according to an illustrative embodiment;

FIG. 5 is a seating map of a second arena with seating levels usable for determining equitable ticket exchange according to an illustrative embodiment;

FIG. 6 is an exemplary interface for a ticket exchange marketplace in accordance with an illustrative embodiment;

FIG. 7 is a swim lane diagram depicting data flow during a process for ticket exchange according to an illustrative embodiment;

FIG. 8 is a flowchart of a process for ticket exchange at a server according to an illustrative embodiment; and

FIG. 9 is a flowchart of a process for ticket exchange at a client device according to an illustrative embodiment.

### DETAILED DESCRIPTION

As already described, facilitating attendance of season ticket holders can result in an increase in overall revenue. An ancillary benefit can also be recognized by season tickets holders who might not be able to attend every home game that their team plays. For example, in the United States a professional basketball team plays 82 games with roughly half of them home games. Season tickets allow a purchaser to attend each of the home games. In some instances, depending on the type of season ticket, the purchaser may also be entitled to attend other events hosted at the home team's arena. For example, the purchaser may also receive tickets for concerts and other shows.

A season ticket holder that cannot attend an event, such as a game or concert, is often relegated to giving away the tickets to friends or family, or to sell the tickets on a secondary ticket marketplace. Giving the season tickets to friends or family means that the season ticket holder has not recouped the cost of the tickets, and the amount of time and effort to coordinate the transaction might dissuade the season ticket holder from even attempting to find someone to attend instead. Selling the ticket on a secondary ticket marketplace may result in a sale of the ticket, but oftentimes third-party fees result in an unacceptable low return on the sale of the tickets. Other times, event attendees may use the secondary ticket marketplace to identify empty seats in preferred sections of the arena and simply sit in the empty seats once the event has started, without purchasing any tickets.

Novel aspects of this disclosure recognize the need to increase attendance at events to increase revenue generation. Novel aspects of this disclosure also recognize that season ticket holders may want an exchange in kind rather than to simply gift or sell the tickets to someone else. For example, a season ticket holder who cannot attend a home game may wish to offer their tickets for exchange so that the season ticket holder can attend a different event, e.g., an away game on a different date. Thus, novel aspects of this disclosure provide for a ticket exchange marketplace that enables season ticket holders to trade tickets with other season ticket holders based on exchange criteria that takes into consideration metrics such as a ticket grade. As used herein, a ticket grade is a metric that determines the desirability of a seat associated with a ticket. For example, most professional basketball arenas sell tickets in one of four seating levels that are differentiated based on distance from the basketball court. In most arenas, the most expensive and most desirable seats are almost universally termed “courtside seats”. In this disclosure, these seats are floor level seats, and they correspond with Tier 1 tickets. The other three seating levels be given different names depending upon the naming convention of a particular arena. For example, one professional basketball arena identifies the remaining three seating levels as “Lower Level”, “Platinum Level”, and “Upper Level” in order of increasing distance from the basketball court and correspond to Tier 2, Tier 3, and Tier 4 tickets, respectively.

In another embodiment, the ticket grade can be based on different criteria such as ticket cost if, for example, two different arenas have different number of seating levels, i.e., a first arena assigns tickets to one of four seating levels and a second arena assigns tickets to one of five seating levels. In yet another embodiment, the ticket grade can be based on an actual distance from the playing field.

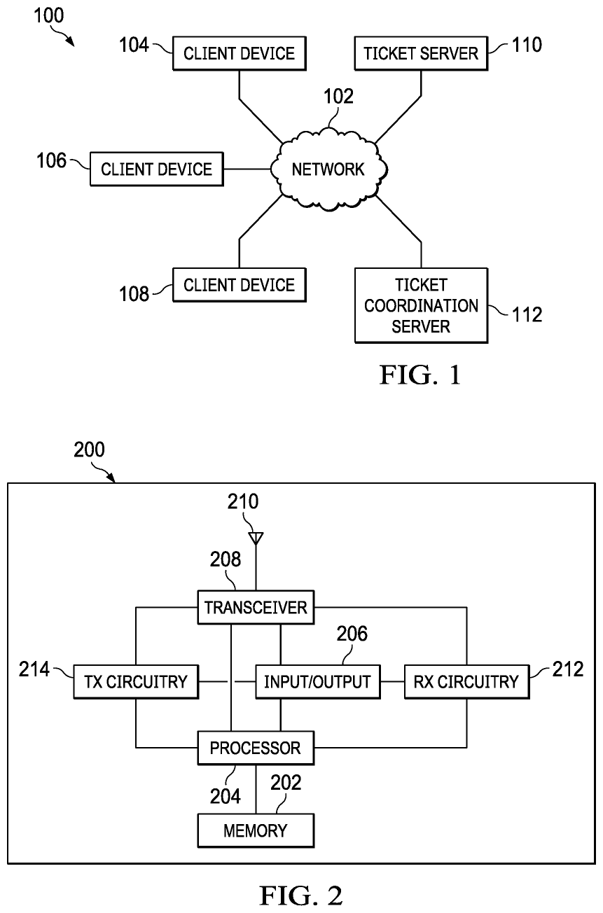

FIG. 1 is a block diagram of a system for ticket exchange according to an illustrative embodiment. The system 100 includes a plurality of electronic devices communicating via a network 102 to permit users to participate in a ticket acquisition and exchange. In this example, users of system 100 can operate one of the client devices 104, 106, or 108 to acquire tickets. Examples of client devices 104, 106, and 108 can include cell phones, tablets, desktop computers, or any other form of computing device. While client devices 104, 106, and 108 are depicted as communicating through communications link via network 102, in other embodiments, the client devices 104, 106, and 108 can communicate via device-to-device communications protocols.

The tickets can be acquired by users from ticket server 110. In this embodiment, ticket server 110 is one or more ticket servers that manage the inventory of seats for one or more arenas and provides payment processing services. Ticket purchases can be accomplished via conventional means, such as online websites interfacing with the ticket server 110.

Ticket exchange server 112 facilitates the exchange of tickets between ticket holders after purchase. In one embodiment, the ticket exchange server 112 interfaces with the ticket server 110 to obtain ticket data of ticket holders that are users of system 100 to participate in ticket exchanges. Examples of ticket data include purchaser information and ticket information, such as number of seats, number of games, and ticket price. Once the ticket exchange server 112 receives a communication from users through one of the client devices 104, 106, and 108, the ticket exchange server 112 can identify all the tickets available for exchange between users of the ticket exchange marketplace. In some embodiments, the ticket exchange marketplace is responsible for the actual exchange of tickets between users of the ticket exchange marketplace. In other embodiments the ticket exchange marketplace facilitates communication between users to conduct the ticket exchanges between themselves.

FIG. 2 is a block diagram of a mobile computing device for ticket exchange according to an illustrative embodiment. The client device 200 is provided for illustration only. The client devices 104, 106, and 108 in FIG. 1 can have the same or similar configuration as the client device 200 in FIG. 2.

Client device 200 includes memory 202 storing instructions that can be executed by processor 204 for controlling the operation of the client device 200. For example, the memory can store an operating system and one or more applications that can be executed by the processor 204. The memory 202 can include random access memory (RAM), Flash memory, and/or read-only memory (ROM).

I/O 206 is one or more input/output (I/O) devices of the client device 200. Examples of I/O devices include, but are not limited to, a microphone, a speaker, a camera, a touch screen, a keypad. I/O 206 enables a user to interact with the client device 200 to purchase tickets and participate in a ticket exchange marketplace as described in this disclosure. In some embodiments, I/O 206 also includes I/O interfaces that provide the client device 200 with communications paths with other devices, such as other client devices and peripherals.

The transceiver 208 provides a wireless communications capability with a network, such as network 102 in FIG. 1. Incoming signals are received by the transceiver 208 from the antenna 210 and processed by the receive (RX) circuitry 212, which processes the signal and transmits the processed signal to an I/O device, such as a speaker, if the processed signal is for voice data. The processed signal can also be transmitted to the processor 204 for further processing before presentation to a user on another I/O device, such as a screen, if the processed signal is for other forms of data, such as web browsing data. Outgoing signals transmitted by the transceiver 208 from the antenna 210 are received from transmit (TX) circuitry 214. The TX circuitry 214 can receive voice data from a microphone, or other forms of outgoing data, such as web data, e-mail, or application data, from the processor 204.

The client device 200 in FIG. 2 is depicted as a mobile phone, the client device 200 can be any other conventional client computing devices such as tablets, laptop computers, and desktop computers. For example, the transceiver depicted in the client device 200 can be replaced by a network communications interface that can support wired or wireless communication over a user's home network.

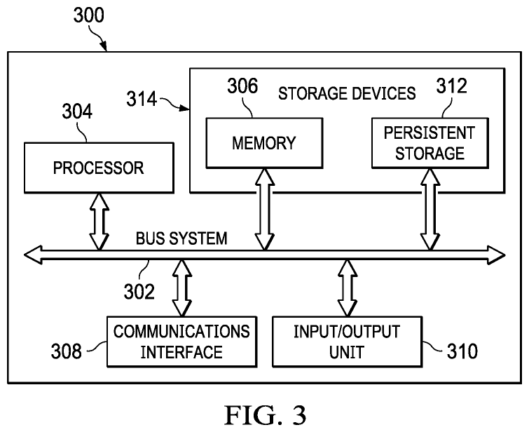

FIG. 3 is a block diagram of a server for ticket exchange according to an illustrative embodiment. For example, the server 300 can be a ticket server 110 in FIG. 1 or a ticket exchange server 112 in FIG. 1.

Server 300 includes a bus system 302 that supports communication between at least one processor 304, at least one storage device 314, at least one communications interface 308, and at least one input/output (I/O) unit 310.

The memory 306 and a persistent storage 312 are examples of storage devices 314, which represent any structure(s) capable of storing and facilitating retrieval of information (such as data, program code, and/or other suitable information on a temporary or permanent basis). The memory 306 may represent a random access memory or any other suitable volatile or non-volatile storage device(s). The persistent storage 312 may contain one or more components or devices supporting longer-term storage of data, such as a read only memory, hard drive, Flash memory, or optical disc.

The processor 304 may execute instructions that may be loaded into the memory 306. The processor 304 may include any suitable number(s) and type(s) of processors or other devices in any suitable arrangement. Example types of processors 304 include microprocessors, microcontrollers, digital signal processors, field programmable gate arrays, application specific integrated circuits, and discreet circuitry.

The communications interface 308 may support communications with other systems or devices. For example, the communications interface 308 could include a network interface card or a wireless transceiver facilitating communications over the network 102. The communications interface 308 may support communications through any suitable physical or wireless communication link(s).

The I/O unit 310 may allow for input and output of data. For example, the I/O unit 310 may provide a connection for user input through a keyboard, mouse, keypad, touchscreen, or other suitable input device. The I/O unit 310 may also send output to a display, printer, or other suitable output device.

As described in more detail below, the server 300 can be implemented as a ticket exchange server in a networked computing system and can coordinate an exchange of tickets between season ticket holders operating client devices.

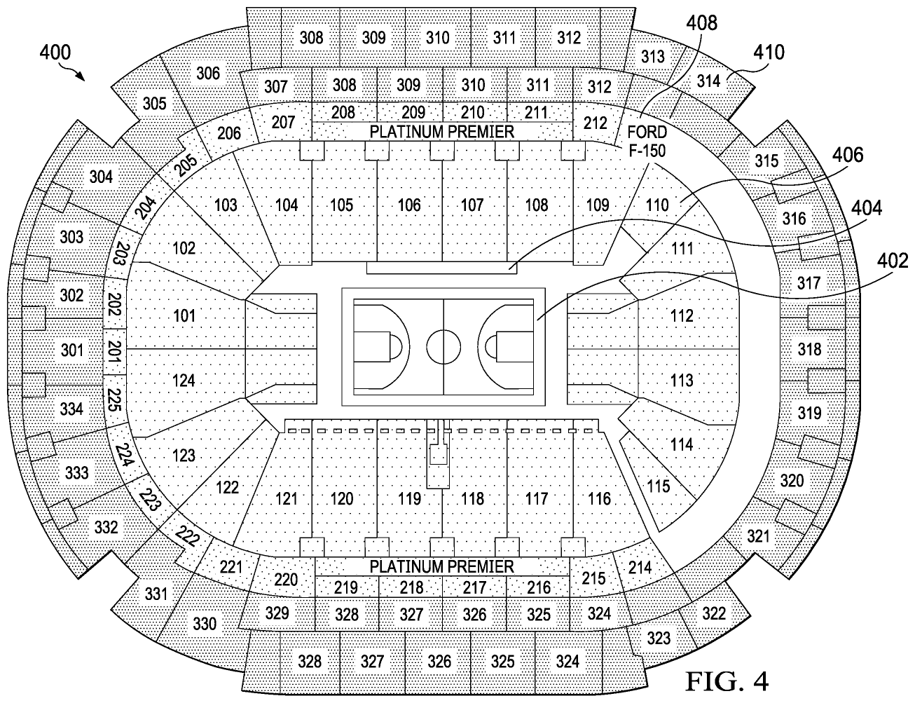

FIG. 4 is a seating map of a first arena with seating levels usable for determining equitable ticket exchange according to an illustrative embodiment. The arena 400 includes a playing field 402 at the center, surrounded by a plurality of seats. The seats are located in sections that can be assigned to a ticket grade based on the desirability of the seat. In this illustrative embodiment, the desirability is based on the distance from the playing field 402. For example, seats in section 118 are generally more desirable than seats in section 326, which are further from the playing field 402. In other embodiments, the desirability of seats can also be based on location within the arena 400 in addition to distance. For example, seats in section 118 are generally more desirable than seats in section 113 even though the seats may be approximately the same distance from the playing field 402 because the seats provide a more complete view of the entire playing field 402 whereas seats in section 118 provide a view of only one end of the playing field 402.

In this illustrative embodiment, the arena 400 is divided into four seating levels based on distance from the playing field 402. The first seating level 404 is for the most expensive and desirable seats, i.e., Tier 1 tickets. The second seating level 406, the third seating level 408, and the fourth seating level 410 are for progressively less expensive and less desirable seats. Seating levels 406, 408, and 410 correspond to Tier 2 tickets, Tier 3 tickets, and Tier 4 tickets, respectively.

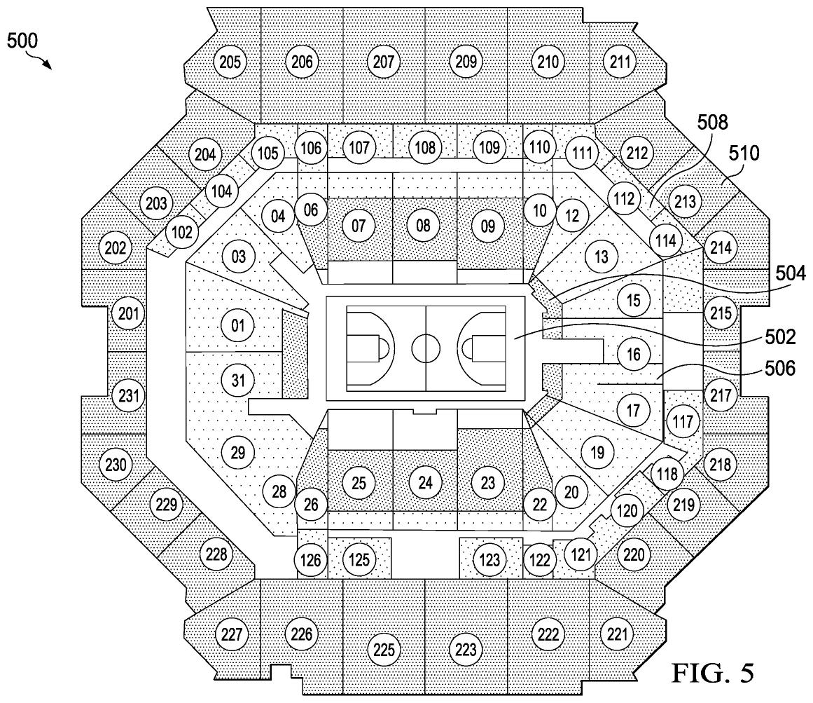

FIG. 5 is a seating map of a second arena with seating levels usable for determining equitable ticket exchange according to an illustrative embodiment. The arena 500 includes a playing field 502 at the center, surrounded by a plurality of seats. The seats are located in sections that can be assigned to a ticket grade based on the desirability of the seat. In this illustrative embodiment, the desirability is based on the distance from the playing field 502.

In this illustrative embodiment, the arena 500 is divided into four seating levels based on distance from the playing field 502. The first seating level 504 is for the most expensive and desirable seats, i.e., Tier 1 tickets. The second seating level 506, the third seating level 508, and the fourth seating level 510 are for progressively less expensive and less desirable seats. Seating levels 506, 508, and 510 correspond to Tier 2 tickets, Tier 3 tickets, and Tier 4 tickets, respectively.

In one embodiment, users who have offered some tickets for exchange for events hosted in a first arena, e.g., arena 400 in FIG. 4, are entitled to participate in a ticket exchange with other users who have also offered some tickets for exchange for events hosted in a second arena, e.g., arena 500 in FIG. 5. A ticket exchange server, such as ticket exchange server 112 in FIG. 1 aggregates all the tickets offered for exchange and facilitates the ticket exchange between users of a ticket exchange marketplace. The ticket exchange server 112 can also send out notifications to users as new tickets are added to the collection of tickets available for exchange. For example, in most scenarios users will know of engagements at the start of the season that would require them to miss one or more games during the season. Thus, the users can notify the ticket exchange server 112 at the start of the season of the games that the users cannot attend. At or around that time, the users can also claim one or more tickets based on the tickets that were offered for trade.

A user that discovers a scheduling conflict during the season can still offer tickets up for trade provided that the offer does not violate a system-imposed deadline. For example, the ticket exchange server 112 may accept ticket trade offers for an event up until two weeks in advance of the event. Users can be notified of newly offered tickets as soon as the tickets are offered for exchange so that users who were unable to identify desirable tickets earlier can still have the opportunity to acquire tickets for newly offered events.

In some embodiment, the ticket exchange server 112 controls ticket exchanges to ensure equitable exchanges. For example, a season ticket holder offering two Tier 4 tickets at arena 400 for trade should not be able to receive two Tier 1 tickets at arena 500 in exchange because the ticket exchange would be inequitable. Thus, the ticket exchange server 112 can impose trade restrictions. In one embodiment, ticket exchanges can be made on a one-to-one basis and restricted based on some predetermined criteria. For example, a user offering two Tier 1 tickets for exchange for seats at arena 400 can obtain two Tier 1 tickets for a different event at arena 500. In embodiments where ticket grade is determined not on seating level but instead on ticket cost, a user offering two tickets for trade can request and obtain two tickets of the same or similar value for a different event, irrespective of actual seating level. In embodiments where ticket grade is determined based on distance from the playing field, then a user offering two tickets at a predetermined distance from the playing field can request and obtain two tickets for a different event at a same or similar predetermined distance from the playing field, irrespective of seating level or ticket costs.

In other embodiments, the ticket exchange can be completed on a one-to-many basis. Thus, when ticket grade is based on seating level, a user who offers two Tier 1 tickets for trade can select more than two tickets for another event until the value of the exchange is deemed to be equitable. Equity can be predetermined by rules in advance. For example, rules may indicate that a Tier 1 ticket has the same value as two Tier 2 tickets, four Tier 3 tickets, and six Tier 4 tickets. Thus, a user who offers two Tier 1 tickets for trade can request and receive four Tier 2 tickets to another event. Alternatively, that user can select two Tier 2 tickets for an event on a first day and two Tier 2 tickets for an event on a second day. The user can select any combination of tickets on the same or different days until the value of the exchange is determined to be equitable.

The same one-to-many exchange can be implemented when ticket grade is based on ticket cost. For example, a ticket holder offering two floor tickets that retail for $1,000 each can request and receive one or more tickets on the same or different day until the value of the exchange has been equalized.

In the event that a ticket holder's ticket has been offered for exchange, but not accepted by another user by some deadline, e.g., a week before the event, then the ticket exchange server 112 can list the tickets on another secondary ticket marketplace for sale to the general public. Proceeds of the sale can be distributed according to predefined rules. For example, if the original owner of the tickets was unable to acquire suitable tickets despite offering their tickets up for trade, then the proceeds of the sale can be returned to the original owner. Alternatively, the proceeds of the sale can be split between the original owner of the ticket and the operator of the ticket exchange server 112. In a scenario where the original ticket owner was able to acquire tickets from the ticket exchange marketplace, but the original ticket owner's tickets were not claimed by another user of the ticket exchange marketplace, then proceeds of the ticket sale can be retained by the operator of the ticket exchange server 112 for optional distribution to another user of the ticket exchange marketplace, in whole or in part.

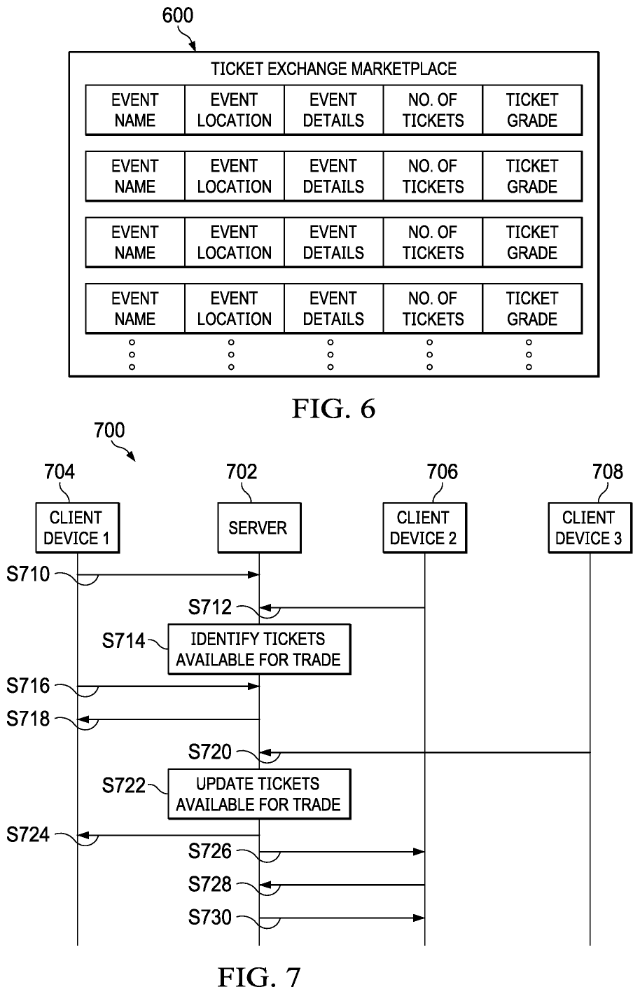

FIG. 6 is an exemplary interface for a ticket exchange marketplace in accordance with an illustrative embodiment. The ticket exchange marketplace 600 is a virtual marketplace that can be hosted by a ticket exchange server, such as a ticket exchange server 112 in FIG. 1 for access by season ticket holders operating one of the client devices 104, 106, or 108 in FIG. 1.

Information displayed in the ticket exchange marketplace 600 should be sufficient to enable users to identify events of interest and submit requests for tickets. In this illustrative embodiment in FIG. 6, the information included in the ticket exchange marketplace 600 includes an event name, an event location, event details, a number of tickets, and a ticket grade. While the information displayed in the ticket exchange marketplace 600 is in tabular format with each row corresponding to a set of tickets offered for exchange, the information can be displayed to users in any number alternate, conventional formats.

FIG. 7 is a swim lane diagram depicting data flow between electronic devices during an exemplary process for ticket exchange according to an illustrative embodiment. The electronic devices depicted in the diagram 700 include ticket exchange server 702, client device 1 704, client device 2 706, and client device 3 708. The ticket exchange server 702 is a ticket exchange server, such as ticket exchange server 112 in FIG. 1, and the client devices 1-3 are client devices, such as client devices 104, 106, and 108 in FIG. 1. Operators of each of the client devices 1-3 are unique season ticket holders and users of the ticket exchange marketplace hosted on the ticket exchange server 702. Communication between the computing devices occurs over a network, such as network 102 in FIG. 1.

In this illustrative embodiment in FIG. 7, users of client device 1 704, client device 2 706, and client device 3 708 have each acquired season tickets. The tickets can be acquired from a ticket server, such as ticket server 110 in FIG. 1. In S710 a message is submitted from client device 1 704 to the ticket exchange server 702 offering a set of tickets for trade. Likewise, in S712 a message is submitted from client device 2 706 to the ticket exchange server 702 offering a set of tickets for trade. In S714, the ticket exchange server 702 identifies the tickets available for trade based on ticket exchange offers received from users, e.g., from client device 1 704 and client device 2 706 sent in the messages transmitted during S710 and S712. In some embodiments, identification of tickets available for trade includes an optional filtering step of the available tickets for trade so that users can only be provided access to tickets that would result in an equitable trade.

In this example in FIG. 7, after a user operating client device 1 704 has browsed all the tickets available for trade in the ticket exchange marketplace and identified suitable tickets for acquisition, a request for tickets is submitted to ticket exchange server 702 in S716. In S718, the ticket exchange server 702 returns a response to the client device 1 704 which declines the request or fulfils the request. The response can decline the request from client device 1 704 if the tickets have already been claimed, or the response can confirm that the user operating client device 1 704 has successfully acquired a new set of tickets from the ticket exchange marketplace. In one embodiment, the response includes the requested tickets as well as an account summary indicating whether the client device 1 704 is entitled to select any additional tickets. In another embodiment, the response includes a means to communicate with the original ticket holder so that the trade of the tickets can be completed. For example, the response can include contact information of the original ticket holder.

In this example in FIG. 7, the user operating client device 3 708 did not offer tickets for exchange at the start of the process but only offered a set of tickets for exchange sometime after ticket exchange offers were already transmitted from client device 1 704 and client device 2 706. This result could be attributed a mid-season acquisition of season tickets or an unexpected scheduling conflict that arose at a later date. In either event, a user operating client device 3 708 transmits a message offering a set of tickets for exchange in S720. In S722 the ticket exchange server 702 updates the tickets available for trade and then sends out notifications to the other client devices of the ticket exchange marketplace who may be entitled to receive the tickets offered from client device 3 708. In this example, client device 1 704 and client device 2 706 are provided with notifications in S724 and S726, respectively, indicating that new tickets have been offered for exchange on the ticket exchange marketplace. In this illustrative example, client device 1 704 offered up a sufficient number of tickets for trade to be eligible to continue to request additional tickets from the ticket exchange marketplace. In S728 a user operating client device 2 706 submits a request for tickets to ticket exchange server 702 and in S730 the ticket exchange server 702 returns a response to client device 2 706 either declining the request or fulfilling the request.

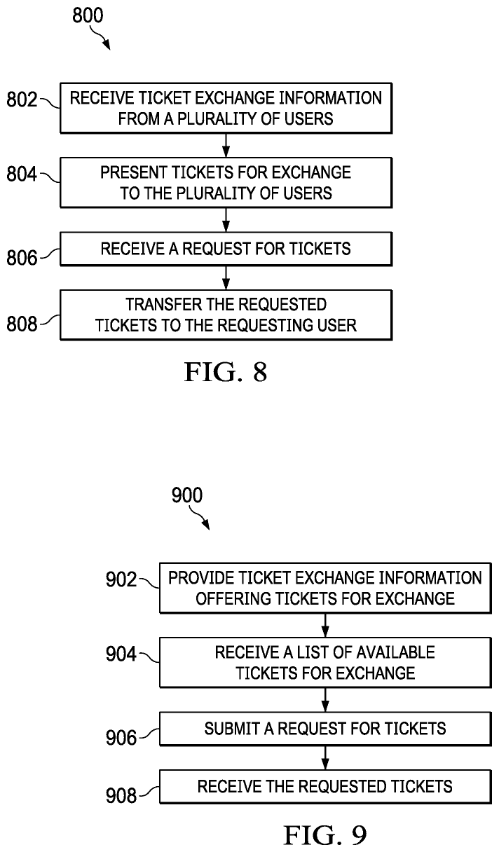

FIG. 8 is a flowchart of a process for ticket exchange at a server according to an illustrative embodiment. The steps of flowchart 800 can be implemented by a ticket exchange server, such as ticket exchange server 112 in FIG. 1.

Flowchart 800 begins at step 802 by receiving ticket exchange information from a plurality of users offering tickets for exchange. In some embodiments, each of the plurality of users are season ticket holders with a set of tickets permitting attendance to a plurality of events over a period of time. For example, the plurality of events can be the home games for a professional sports team at a particular arena, and the period of time can be the length of a season. The plurality of events can also include events that take place at the arena during the season, but which are unaffiliated with the sports team. The ticket exchange information can identify at least an event and seating information for the event.

In step 804, tickets are presented for exchange to the plurality of users. In a particular embodiment, the tickets are presented to registered users of a ticket exchange marketplace. The tickets can be presented in a format with search capabilities to facilitate searching.

In some embodiments, the step of presenting tickets for exchange to the plurality of users includes filtering the set of tickets to generate filtered ticket results that only allow equitable ticket trades. Thereafter, the filtered ticket results can be presented to the plurality of users. Equity of ticket trades can be based on, at least in part, a ticket grade. The ticket grade can be based on one of a seating level, a ticket cost, and a distance from the playing field.

In Step 806, a request is received from a requesting user from the plurality of users for tickets from the tickets for exchange.

In step 808, the requested tickets are transferred from an original owner of the tickets to the requesting user. In some embodiments, facilitating transfer of the tickets can include sending the requested tickets to the requesting user. In some other embodiments, facilitating transfer of the tickets can include providing a means of communication to allow the requesting user and the original ticket owner to complete the ticket exchange. For example, users can be provided with contact information so that the ticket exchange can be conducted offline. Alternatively, the users can be provided with direct messaging capability over a proprietary platform for communicating without disclosing user identities.

In some embodiments, the ticket exchange server can access data from one or more ticket servers, e.g., via an application program interface (API) to access season ticket holder data. In those embodiments, the process can include the additional steps of interfacing with a ticket server and obtaining ticket information for the registered users.

In some embodiments, the process can include the optional step of notifying at least some of the plurality of users of newly available tickets for exchange.

FIG. 9 is a flowchart of a process for ticket exchange at a client device according to an illustrative embodiment. The steps of flowchart 900 can be implemented by a client device, such as client device 104, 106, or 108 in FIG. 1. The client device can be operated by a season ticket holder that is also a user of a ticket exchange marketplace as described herein.

The process starts at Step 902 by providing ticket exchange information that offers one or more tickets for exchange. The one or more tickets permit attendance to a plurality of events over a period of time. For example, the plurality of events can be every home game for a sports team playing and the period of time can be the duration of the season. The ticket exchange information identifies at least an event and seating information for the event. The event can be identified in any conventional manner, i.e., by date and participating team names, and the seating information can include seat number(s) and/or seat section(s).

The process continues to Step 904 by receiving a list of available tickets for exchange offered by other users. In some embodiments, the list of available tickets includes only the tickets that a particular user is entitled to receive based on a ticket grade of the ticket(s) offered for trade, which ensures that the ticket trades are equitable. Equity of ticket trades can be based on, at least in part, a ticket grade. The ticket grade can be determined by one of a seating level, a ticket cost, and a distance from the playing field.

In Step 906, a request for tickets from the available tickets is submitted. In Step 908 the requested tickets are received. If the tickets are no longer available, i.e., if another user has already claimed the tickets, or if the original owner has withdrawn the offer for trade, then the tickets are not received by the requesting user.

In some embodiments, the other users are registered users of a ticket exchange marketplace.

In some embodiments, the process described in flowchart 900 can include the step of receiving a notification of newly available tickets for exchange.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method for ticket exchange, the method comprising:
receiving ticket exchange information from a plurality of users offering tickets for exchange, wherein each of the plurality of users are season ticket holders with a set of tickets permitting attendance to a plurality of events over a period of time, and wherein the ticket exchange information identifies at least an event and seating information for the event;
presenting the tickets for exchange to the plurality of users;
receiving a request from a requesting user from the plurality of users for tickets from the tickets for exchange; and
transferring the requested tickets from an original owner of the tickets to the requesting user.

2. The method of claim 1, wherein the tickets for exchange are presented to registered users of a ticket exchange marketplace.

3. The method of claim 2, further comprising:
interfacing with a ticket server; and
obtaining ticket information for the registered users.

4. The method of claim 1, wherein presenting the tickets for exchange further comprises:
filtering the set of tickets to generate filtered ticket results that only allow equitable ticket trades; and
presenting the filtered ticket results to the plurality of users.

5. The method of claim 4, wherein the equitable ticket trades are based on, at least in part, a ticket grade.

6. The method of claim 5, wherein the ticket grade is determined by one of a seating level, a ticket cost, and a distance from the playing field.

7. The method of claim 1, further comprising:
notifying at least some of the plurality of users of newly available tickets for exchange.

8. The method of claim 1, wherein transferring the tickets further comprises one of sending the requested tickets to the requesting user or providing a means of communication to allow the requesting user and the original ticket owner to complete the ticket exchange.

9. An apparatus comprising:
memory configured to store instructions; and
a processor coupled with the memory, wherein the processor is configured to execute the instructions to:
receive ticket exchange information from a plurality of users offering tickets for exchange, wherein each of the plurality of users are season ticket holders with a set of tickets permitting attendance to a plurality of events over a period of time, and wherein the ticket exchange information identifies at least an event and seating information for the event;
present the tickets for exchange to the plurality of users;
receive a request from a requesting user from the plurality of users for tickets from the tickets for exchange; and
transfer the tickets from an original owner of the tickets to the requesting user.

10. The apparatus of claim 9, wherein the processor further executes the instructions to present the tickets for exchange to registered users of a ticket exchange marketplace.

11. The apparatus of claim 10, wherein the processor further executes the instructions to:
interface with a ticket server; and
obtain ticket information for the registered users, wherein at least some of the ticket information presented in the ticket exchange marketplace.

12. The apparatus of claim 9, wherein the processor further executes the instructions for presenting the tickets for exchange to:
filter the set of tickets to generate filtered ticket results that only allow equitable ticket trades; and
present the filtered ticket results to the plurality of users.

13. The apparatus of claim 12, wherein the equitable ticket trades are based on, at least in part, a ticket grade.

14. The apparatus of claim 13, wherein the processor further executes the instructions for presenting the tickets for exchange to determine a ticket grade based on one of a seating level, a ticket cost, and a distance from the playing field.

15. The apparatus of claim 9, wherein the processor further executes the instructions to:
notify at least some of the plurality of users of newly available tickets for exchange.

16. The apparatus of claim 9, wherein the processor executes the instructions to transfer the tickets to send the requested tickets to the requesting user or provide a means of communication to allow the requesting user and the original ticket owner to complete the ticket exchange.

17. A method for ticket exchange, the method comprising:
providing ticket exchange information offering one or more tickets for exchange, wherein the one or more tickets permit attendance to a plurality of events over a period of time, and wherein the ticket exchange information identifies at least an event and seating information for the event;
receiving a list of available tickets for exchange offered by other users, wherein the list of available tickets includes filtered ticket results that allow equitable ticket trades;
submitting a request for tickets from the available tickets for exchange; and
receiving the requested tickets.

18. The method of claim 17, wherein the other users are registered users of a ticket exchange marketplace.

19. The method of claim 17, wherein the equitable ticket trades are based on, at least in part, a ticket grade.

20. The method of claim 19, wherein the ticket grade is determined by one of a seating level, a ticket cost, and a distance from the playing field.
